(19) United States
(12) Patent Application Publication
(10) Pub. No.: US 2008/0120397 A1
(43) Pub. Date: May 22, 2008

(54) Peer-to-peer social networking optimization engine

(76) Inventor: Jalali Hancock Hartman, Neptune Beach, FL (US)

Correspondence Address: Jalali Hartman, 1835 Nightfall Drive, Neptune Beach, FL, 32266, US

(21) Appl. No.: 11/974,617

(22) Filed: Oct. 15, 2007

Related U.S. Application Data
(60) Provisional application No. 60/863,450, filed on Oct. 30, 2006.

(51) Int. Cl. G06F 15/16

(52) U.S. Cl. 709/218

(57) ABSTRACT

The Social Marketing Optimization Engine is a web-based technology that allows for the automatic distribution of video, audio, graphical or text-based content to multiple websites, with built-in optimization of the content so that it automatically has a higher probability of being viewed within a socially-driven website. It is based on the Social Networking Index, a mathematical formula which describes the relationship between the content being distributed, the number of connection points within the network, the initial size of the community, the ratio by which individuals share content with each other and finally an estimate of the overall growth behavior of the network—or ultimately it's value. When utilized properly, a content publisher can increase overall content consumption through a variety of social networks and online websites, as well as save them time and resources, as well as build a large ‘fan base’ or community, through which to push additional content to, including marketing messages.

### CROSS-REFERENCE TO RELATED APPLICATIONS

BE IT KNOWN THAT I, Jalali H. Hartman, a citizen of the United States, living at 1835 Nightfall Drive, Neptune Beach, Fla. 32266, has invented a new and useful technology and methodology for the distribution of content through social networks, of which the following is a specification, in reference to provisional patent application 60/863,450 filed on Oct. 30, 2006.

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND ON THE INVENTION

1. Field of the Invention

The present invention relates generally to social marketing engines and more specifically the distribution and optimization of content through these engines. The purpose of this invention is to allow artists, musicians, filmmakers and content publishers to have the ability to distribute their content online is such a way as to increase the chances that it will be viewed by the public.

2. Description of Related Art

It can be appreciated that social marketing engines have been in use for years. In addition online content distribution systems have existed for years. Online media-based marketplaces such as YouTube, MySpace, Google Groups and Facebook allow content publishers to reach a large audience. Typically, the content that is naturally the most relevant or popular gets viewed the most.

The main problem with these marketplaces is that it is difficult to control the spread of content through a given marketplace (described in this application as social networks). From a professional content publisher or producer standpoint, having one's content propagate through these marketplaces is incredibly valuable, as content items have the potential to be viewed millions or even billions of times by a global audience.

While these social networks may be suitable for casual communication with the community within them, and while they may be effective places to advertise, there is not currently a system for optimizing AND distributing content through one or all applicable networks, in such a way as to increase the likelihood that an individual content publishers article, photo, music clip or video content will be seen and viewed before other relevant content items.

### SUMMARY OF THE INVENTION

In respect to these limitations, the PEER-TO-PEER SOCIAL NETWORKING OPTIMIZATION ENGINE, provides content a technology based around a methodology for content creation and distribution that increases the probability that a given content item will be viewed, and subsequently passed from person to person, within a given network, or group of networks, thus providing a vibrant channel for advertisers, publishers, marketers, artists, performers and musicians to publish content through.

A proprietary methodology has been developed for the distribution and optimization of content through social networks, online websites and search engines, where social networks include any web property where content is ranked or tagged and thus made more relevant by individual users. The PEER-TO-PEER SOCIAL NETWORKING OPTIMIZATION ENGINE is a methodology based on the following mathematical formula (FIG. 1) and which allows publishers of video, print, images and other web-borne content to gain increased exposure through online video sharing sites, social networks, discussion forums, blogs and community powered social search engines (FIG. 2).

### DETAILED DESCRIPTION OF THE INVENTION

The core technology is a Java/PHP/SQL/HTML based web application (FIG. 2) that enables the Social Network Index to be implemented on a large scale. While it does require initial input of content, the technology significantly reduces the time and effort required for one content publisher to publish content to multiple locations, in a format that will be both accepted and automatically optimized for a given social network.

The technology consists of 3 separate primary components, each with a separate function and design.

Object 1: User Interface

The user interface allows a web-based user to login to a web address and create basic profile information, such as company name, contact information, interests, categories and preferences. A second object of the user interface includes a content submission formation, which allows the user to place video, picture, sound or text content into an online interface for formatting and distribution to multiple networks.

Object 2: Optimization & Distribution Engine

The optimization and distribution engine automatically reformats the content to a format that will be accepted for distribution to the largest potential number of social networks and content websites. (At time of this application, there are 143 unique networks where content can be distributed). A second object of the engine is to include keywords and changes in actual copy and file names that will allow it to be found more easily within the applicable social networks.

Object 3: Group Messaging System

The group messaging system allows for end-users (viewers of the content) to subscribe to RSS feeds, news feeds, email lists and various social-network-specific notification systems, and be automatically notified when a new content items (or items) from a given publisher becomes available. This notification system allows for the viral growth of a given content set, because each time a publisher releases new content, the size of the distribution network is effectively larger (because of previous ‘subscribers’.

These technology components works on harmony to effectively distribute more content, and increase the probability that it will be viewed by effectively growing the size of the social network, and subsequently the overall traffic for a publisher. The technology is unique and proprietary, however it simply allows the 4 variables of the Social Network Index (S) (FIG. 1) to be manipulated more easily and quickly. Essentially, a publisher can increase the size (and value) of his or her social network by placing more relevant content (C) in more places (N) and with a higher chance that it will be spread (V).

Similar programs and methodologies exist that allow publishers to distribute content to multiple sites, however what is unique about this invention is the optimization methodology that depends heavily on how other members of the network respond to and subsequently rate a given content item. This invention also builds an audience for a publisher, which allows future content items to be automatically viewed. Both the underlying methodology and the technology automatically facilitate this increase in user feedback, which in turn creates more user feedback (FIGS. 3,4)

Drawings

Social Network Index (S)
S=(C₁)C×N×Y)^{v}
Where:
C₁=a coefficient which places added value on the content the publisher is attempting to distribute
C=the relevancy and overall value to the audience within the social network
N=the number of nodes, or connections in the network
Y=The initial size of the publishers community, or some form of priming, such as advertising budget
V=A viral ratio, greater than 1, which represents the ration of community members who pass the content along naturally
And finally:
S=the overall value and growth rate of a social network
   FIG. 1 The Social Network Index is at the core of the PEER-TO-PEER SOCIAL NETWORKING OPTIMIZATION ENGINE and describes the perpetual, interrelated nature of social media optimization, wherein exponential growth in the size of a network can be manipulated by optimizing each variable that contributes to the growth of the network. This formula, when optimized, allows the Social Networking Engine to distribute the publisher's content to a larger audience primarily because of the exponential nature of the formula.

[image]

[image]

[image]

1. The practice of manipulating the variables of the Social Network Index as to increase the exposure for a given set of content, and thus increasing the overall value of the Social Network (S), specifically creating content (C) specifically relevant to a given community as an attempt to gain more exposure for one's content, and thus build a stronger network, adding new nodes (N), or connection points purposefully, as a way to increase the strength of a network and finally putting in place mechanisms through which the content stands to be spread more easily by the community, thereby increasing viral growth (V).

2. The actual technology architecture that facilitates these activities, and which automatically distributes pre-optimized content to multiple social networks automatically, as described herein.
